(19) United States
(12) Patent Application Publication
(10) Pub. No.: US 2014/0195795 A1
(43) Pub. Date: Jul. 10, 2014

(54) METHOD AND MOBILE TERMINAL FOR CONFIGURING APPLICATION MODE

(71) Applicant: Huawei Device Co., Ltd., Shenzhen (CN)

(72) Inventors: Pei Wang, Shenzhen (CN); Zhiyan Yang, Shenzhen (CN)

(73) Assignee: Huawei Device Co., Ltd., Shenzhen (CN)

(21) Appl. No.: 14/205,118

(22) Filed: Mar. 11, 2014

Related U.S. Application Data
(63) Continuation of application No. PCT/CN2012/078943, filed on Jul. 20, 2012.

(30) Foreign Application Priority Data
Sep. 13, 2011 (CN) 201110269636.2

(51) Int. Cl. G06F 9/445

(52) U.S. Cl. CPC G06F 9/44505
USPC 713/100

(57) ABSTRACT

Embodiments of the present invention relate to the field of electronic communications, and in particular, to a method and a mobile terminal for configuring an application mode. In the method and device provided by the embodiments of the present invention, the mobile terminal first detects an object material currently in contact with the terminal; compares the detected object material with an object material stored in the terminal; and when the detected object material is the same as the object material stored in the terminal, configures an application mode of the terminal as an application mode corresponding to the object material stored in the terminal. In this way, manual configuration of the application mode for the terminal by a user is omitted, thereby solving a problem that the operation of configuring the application mode is complex.

This is a continuation of International Application No. PCT/CN2012/078943, filed on Jul. 20, 2012, which claims priority to Chinese Patent Application No. 201110269636.2, filed on Sep. 13, 2011 both of which are hereby incorporated herein by reference in their entireties.

### TECHNICAL FIELD

Embodiments of the present invention relate to the field of electronic communications, and in particular, to a method and a mobile terminal for configuring an application mode.

### BACKGROUND

With the popularization of intelligent machines, mobile terminals have become increasingly indispensable to people. However, people often face different life scenarios or work scenarios. In these different scenarios, a mobile terminal needs to be adaptively changed to different application modes. For example, during a meeting, the application mode of the mobile terminal needs to be set to mute or vibration, and keyboard locked. In an office, the application mode of the mobile terminal needs to be set to automatically decreasing the volume, turning off vibration, adjusting screen luminance to adapt to indoor light, turning on Wi-Fi, turning off GPS, and so on. At home, the application mode of the mobile terminal needs to be set to adjusting the volume to a medium level, extending an interval for automatic locking of the screen to twenty minutes, and turning on Wi-Fi.

A user needs to manually set the application mode of the mobile terminal to a desired application mode, so that the user uses an appropriate application mode in a corresponding scenario. However, after the mobile terminal enters a different scenario, the user needs to manually configure the application mode, leading to a problem that the operation of configuring the application mode is complex.

### SUMMARY OF THE INVENTION

Embodiments of the present invention provide a method for configuring an application mode in one aspect, and provide a mobile terminal in another aspect, which can solve a problem that the operation of configuring the application mode is complex.

In order to achieve the foregoing objectives, the embodiments of the present invention adopt the following technical solutions.

A method for configuring an application mode includes detecting an object material currently in contact with a terminal, and comparing the detected object material with an object material stored in the terminal. The method further includes determining whether the detected object material is the same as or different from the object material stored in the terminal, and configuring an application mode of the terminal as an application mode corresponding to the object material stored in the terminal when the detected object material is the same as the object material stored in the terminal.

A method for configuring an application mode includes detecting an object material currently in contact with a terminal and auxiliary information, and comparing the detected object material and auxiliary information with an object material and auxiliary information that are stored in the terminal. The method further includes determining whether the detected object material and auxiliary information are the same as or different from the object material and the auxiliary information that are stored in the terminal and configuring an application mode of the terminal as an application mode corresponding to the object material and the auxiliary information that are stored in the terminal when the detected object material and auxiliary information are the same as the object material and the auxiliary information that are stored in the terminal.

A mobile terminal includes a detecting module configured to detect an object material currently in contact with the terminal. A storing module is configured to store the detected object material and an application mode input. A comparing module is configured to compare the object material detected by the detecting module with an object material stored in the storing module and determine whether the detected object material is the same as or different from the object material stored in the terminal. A configuring module is configured to configure an application mode of the terminal as an application mode corresponding to the object material stored in the terminal when a comparison result of the comparing module is that the object material detected by the detecting module is the same as the object material stored in the storing module.

A mobile terminal includes a detecting module configured to detect an object material currently in contact with a terminal. A storing module is configured to store the detected object material and auxiliary information and an application mode input by a user. A comparing module is configured to compare the object material and the auxiliary information that are detected by the detecting module with an object material and auxiliary information that are stored in the storing module. A configuring module is configured to configure an application mode of the terminal as an application mode corresponding to the object material and the auxiliary information that are stored in the storing module when a comparison result of the comparing module is that the object material and the auxiliary information that are detected by the detecting module are the same as the object material and the auxiliary information that are stored in the storing module.

In the method and device provided by the embodiments of the present invention, the mobile terminal first detects an object material currently in contact with the terminal; compares the detected object material with an object material stored in the terminal; and when the detected object material is the same as the object material stored in the terminal, configures an application mode of the terminal as an application mode corresponding to the object material stored in the terminal. Alternatively, the mobile terminal first detects an object material currently in contact with the terminal and auxiliary information; compares the detected object material and auxiliary information with an object material and auxiliary information that are stored in the terminal; and when the detected object material and auxiliary information are the same as the object material and the auxiliary information that are stored in the terminal, configures an application mode of the terminal as an application mode corresponding to the object material and the auxiliary information that are stored in the terminal.

To sum up, the technical solutions provided by embodiments of the present invention avoid a process of manually configuring an application mode by a user, thereby solving the problem that the operation of configuring the application mode is complex. Therefore, the method and device provided by the embodiments of the present invention may automatically configure the application mode of the terminal according to the detected object material currently in contact with the terminal, or according to the detected object material currently in contact with the terminal and auxiliary information, thereby simplifying an operation of configuring the application mode.

### BRIEF DESCRIPTION OF THE DRAWINGS

To describe the technical solutions in the embodiments of the present invention or in the prior art more clearly, the following briefly introduces accompanying drawings required for describing the embodiments or the prior art. Apparently, the accompanying drawings in the following description show merely some embodiments of the present invention, and a person of ordinary skill in the art may still derive other drawings from these accompanying drawings without creative efforts.

FIG. 1 is a flowchart of a method for configuring an application mode according to an embodiment of the present invention;

FIG. 2 is a flowchart of another method for configuring an application mode according to an embodiment of the present invention;

FIG. 3 is a schematic flowchart of a method for configuring an application mode according to an embodiment of the present invention;

FIG. 4 is a schematic flowchart of another method for configuring an application mode according to an embodiment of the present invention;

FIG. 5 is a schematic structural diagram of a mobile terminal according to an embodiment of the present invention;

FIG. 6 is a schematic structural diagram of another mobile terminal according to an embodiment of the present invention;

FIG. 7 is a schematic structural diagram of still another mobile terminal according to an embodiment of the present invention;

FIG. 8 is a schematic structural diagram of a mobile terminal according to an embodiment of the present invention;

FIG. 9 is a schematic structural diagram of another mobile terminal according to an embodiment of the present invention; and

FIG. 10 is a schematic structural diagram of still another mobile terminal according to an embodiment of the present invention.

### DETAILED DESCRIPTION OF ILLUSTRATIVE EMBODIMENTS

The following clearly describes the technical solutions in the embodiments of the present invention with reference to the accompanying drawings in the embodiments of the present invention. Apparently, the embodiments to be described are merely a part rather than all of the embodiments of the present invention. All other embodiments obtained by a person of ordinary skill in the art based on the embodiments of the present invention without creative efforts shall fall within the protection scope of the present invention.

### Embodiment 1

An embodiment of the present invention provides a method for configuring an application mode, and as shown in FIG. 1, the method includes the following steps.

Step 10: Detect an object material currently in contact with a terminal.

It should be noted that, a sensor for detecting an object material, for example, a temperature tactile sensor, a multifunctional tactile sensor for recognizing a material, and a heat sensation sensor for recognizing a material, needs to be installed on the terminal.

The following uses the multifunctional tactile sensor for recognizing a material as an example to briefly describe a principle and function of the sensor. The multifunctional tactile sensor for recognizing a material has a simple planar structure, but has functions of three sensors. The sensor is formed by two metal coils fabricated on a flexible insulation sheet, and has four input and output terminals. When used as an inductance coil, the sensor presents an inductive function, and may recognize metal and semiconductor materials; when viewed as a planar capacitor, the sensor presents a capacitive function, and may recognize an insulation material; when used in a temperature control circuit, the sensor presents a temperature sensing function. The sensor is capable of recognizing some typical materials, for example, iron, aluminum, copper, brass, rubber, wood, organic glass, foamed plastic, and the like.

Optionally, time of turning on the sensor for detecting an object material of the terminal may be set to always turned on, may also be set to periodically turned on, and may also be set to manually turned on by a user.

Step 12: Compare the detected object material with an object material stored in the terminal.

It should be noted that, the object material stored in the terminal may be preset in the terminal before a cell phone is delivered from a factory, and may also be manually set and stored in the terminal by the user.

Step 14: When the detected object material is the same as the object material stored in the terminal, configure an application mode of the terminal as an application mode corresponding to the object material stored in the terminal.

It should be noted that, the detected object material is compared with object materials stored in the terminal one by one, and when the detected object material is the same as an object material stored in the terminal, the application mode of the terminal is configured to an application mode corresponding to the object material stored in the terminal. The application mode is usage of the terminal by the user, for example, mute, screen brightness, screen locked, Wi-Fi, automatic synchronization, Bluetooth, infrared, vibration, and battery charge level. If the detected object material is wood, and wood is found through searching among the object materials stored in the terminal, an application mode corresponding to wood is further searched for. For example, if an application mode corresponding to wood is mute and screen locked, the application mode of the terminal is automatically set to mute and screen locked.

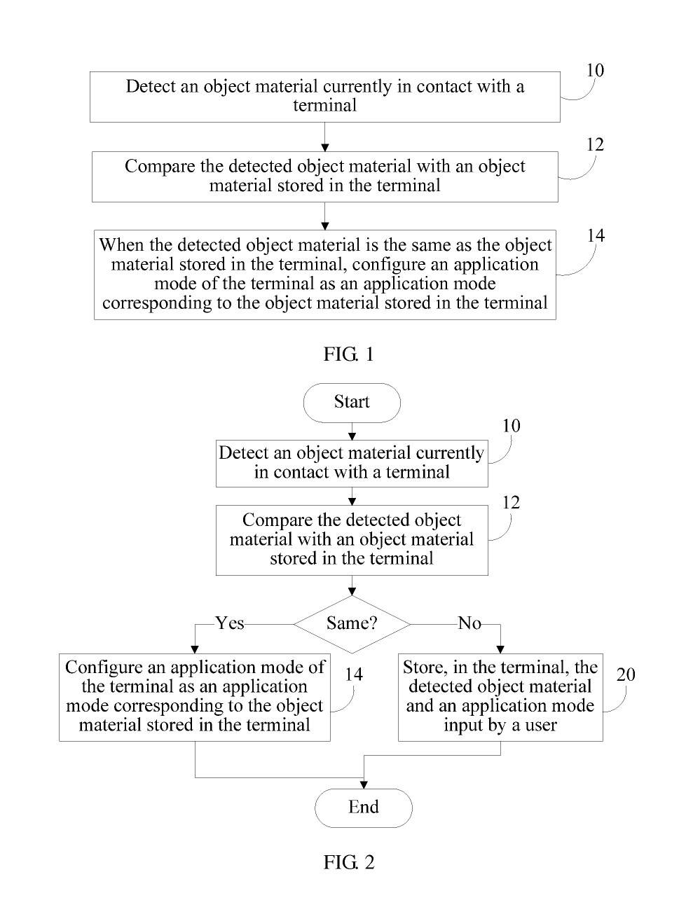

Further, as shown in FIG. 2, when the detected object material is different from all object materials stored in the terminal, perform step 20: Store, in the terminal, the detected object material and an application mode input by the user. It should be noted that, when the detected object material is different from all object materials stored in the terminal, a reminder may be displayed to the user, asking the user whether to add the object material. If the user selects not to add the object material, the terminal discards the detected object material; if the user selects to add the object material, an application mode setting interface is displayed, and the user may set the application mode of the terminal according to the application mode that is to be used for the object material. Finally, the terminal stores, in a storage medium of the terminal, the detected object material and the application mode input by the user. Because manually adding, to the storage medium of the terminal by the user, a detected object material and an application mode input by the user is supported, an increasing number of object materials and application modes corresponding to the object materials will be stored in the terminal, so that a possibility for the terminal to select an object material that is the same as the detected object material greatly increases.

Still further, when the detected object material is a case material of a notebook computer, the terminal enables a wireless connection function, so that the terminal and the notebook computer perform data synchronization, where enabling the wireless connection function may be enabling a Bluetooth connection, and may also be enabling an infrared connection. For example, assuming that the object material of the case material of the notebook computer is metal, the wireless connection function is enabled when the detected object material is metal.

It should be noted that, to implement the function of synchronization between the terminal and the notebook computer, support of synchronization software is required. The synchronization software may be installed in the notebook computer, and in this case, the synchronization software in the notebook computer needs to be always on and keep monitoring a wireless connection, the wireless connection function of the notebook computer is always enabled, and the terminal and the notebook computer may automatically perform data synchronization after a wireless connection is established between the terminal and the notebook computer. Alternatively, the synchronization software may also be installed in the terminal, the synchronization software installed in the terminal needs to be started after the wireless connection function of the terminal is enabled, and the terminal and the notebook computer may automatically perform data synchronization after a wireless connection is established between the terminal and the notebook computer.

In addition, common case materials of notebook computers include an alloy case and a plastic case, where the alloy case includes an aluminum-magnesium alloy and a titanium alloy, and the plastic case includes carbon fiber, polycarbonate PC, and ABS engineering plastic. It should be noted that, object materials of the common case materials of notebook computers may be stored before the terminal is delivered from the factory, and object materials of notebook computers that have been in contact with the cell phone may also be stored by the user during use of the terminal.

Because data synchronization between the terminal and the notebook computer may be enabled as long as the terminal contacts the notebook computer, relevant settings for the user to manually perform data synchronization are omitted, thereby effectively simplifying an operation of configuring the application mode.

Optionally, in consideration of security, before the terminal and the notebook computer perform data synchronization, a prompt may be displayed, so that the user decides whether to perform data synchronization between the terminal and the notebook computer. Because whether to perform data synchronization is completely controlled by the user, security of the terminal is greatly improved, thereby providing good privacy protection for the user.

In the method provided by the embodiment of the present invention, a mobile terminal first detects an object material currently in contact with the terminal; compares the detected object material with an object material stored in the terminal; and when the detected object material is the same as the object material stored in the terminal, configures an application mode of the terminal as an application mode corresponding to the object material stored in the terminal. In this way, manual configuration of the application mode for the terminal by a user is omitted, thereby solving a problem that the operation of configuring the application mode is complex. Therefore, with the method provided by the embodiment of the present invention, the application mode of the terminal may be automatically configured according to the detected object material currently in contact with the terminal, thereby simplifying the operation of configuring the application mode.

### Embodiment 2

An embodiment of the present invention provides another method for configuring an application mode, and as shown in FIG. 3, the method includes the following steps.

Step 30: Detect an object material currently in contact with a terminal and auxiliary information.

A sensor for detecting an object material and setting time of turning on the sensor have been described in Embodiment 1, and details are not repeatedly described herein.

It should be noted that, the auxiliary information is used to assist in detecting the object material currently in contact with the terminal, and the auxiliary information may include a combination of one or more of the following: geographical position, time, date, movement status of the terminal, and brightness status of an environment where the terminal is located. For example, the auxiliary information may include a combination of one or more of the following: geographical position, time, date, movement status of the terminal, and brightness status of an environment where the terminal is located. For a specific example, the auxiliary information may use a combination of the geographical position, time, and date, and in this case, the terminal detects three values, that is, values of the geographical position, time, and date; the auxiliary information may also use the movement status of the terminal, and in this case, the terminal detects one value, that is, a value of the movement status of the terminal; the auxiliary information may also use a combination of the geographical position, time, date, and brightness status of an environment where the terminal is located, and in this case, the terminal detects four values, that is, values of the geographical position, time, date, and brightness status of the environment where the terminal is located. It should be noted that, the auxiliary information may be specified by a user according to a personal requirement, and may also be specified by default when the system is delivered from a factory.

It should be noted that, geographical position information may be obtained through a GPS (Global Positioning System), a base station, or a Wi-Fi (wireless fidelity) access point; the movement status of the terminal may be obtained by using an acceleration sensor in the cell phone, that is, the acceleration sensor in the cell phone may be used to obtain whether the terminal is currently in a moving state; and the brightness status of the environment where the terminal is located may be obtained by using an ambient light sensor in the cell phone.

Step 32: Compare the detected object material and auxiliary information with an object material and auxiliary information that are stored in the terminal.

It should be noted that, the object material stored in the terminal may be preset in the terminal before the cell phone is delivered from a factory, and may also be manually set and stored in the terminal by the user.

It should be noted that, the detected object material and auxiliary information are compared with object materials and auxiliary information that are stored in the terminal one by one. For example, it is assumed that the auxiliary information uses the geographical position, and the object materials and auxiliary information that are stored in the terminal are as follows: 1. wood, Longhua in Shenzhen; 2. metal, Longhua in Shenzhen; and 3. wood, Bantian in Shenzhen. When the detected object material is wood, and the detected geographical position is Bantian in Shenzhen, the detected object material and auxiliary information is compared with the object materials and auxiliary information that are stored in the terminal one by one that, record 1 and record 2 are different from the detected object material and auxiliary information, and record 3 is the same as the detected object material and auxiliary information. Herein, the object material is described in a recording manner that may be understood by people, such as wood and metal, but the object material may be actually recorded by the terminal in another manner, such as temperature and spectrum. In addition, only a manner of comparing the detected object material and auxiliary information with the object materials and the auxiliary information that are stored in the terminal, and determining whether a comparison result is the same are described by using an example herein, and other comparing manners and determining whether the comparison result is the same are not limited.

Step 34: When the detected object material and auxiliary information are the same as the object material and the auxiliary information that are stored in the terminal, configure an application mode of the terminal as an application mode corresponding to the object material and the auxiliary information that are stored in the terminal.

For example, it is assumed that the auxiliary information uses the geographical position, and object materials and auxiliary information that are stored in the terminal and application modes that correspond to the object materials and the auxiliary information and are stored in the terminal are as follows: 1. wood, Longhua in Shenzhen, vibration and screen locked; 2. metal, Longhua in Shenzhen, increasing the volume and turning off the screen; and 3. wood, Bantian in Shenzhen, mute. When the detected object material is wood, and the detected geographical position is Bantian in Shenzhen, the detected object material and auxiliary information is compared with the object materials and auxiliary information that are stored in the terminal one by one that, record 1 and record 2 are different from the detected object material and auxiliary information, and record 3 is the same as the detected object material and auxiliary information. Therefore, the application mode of the terminal is configured as the application mode corresponding to the detected object material and auxiliary information, that is, the application mode of the terminal is set to mute.

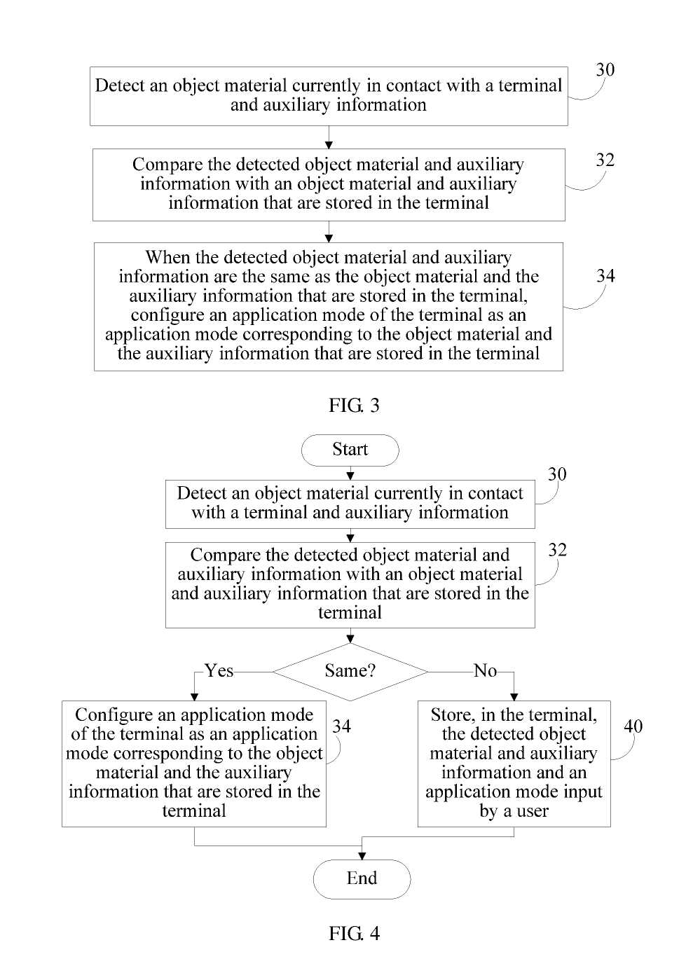

Further, as shown in FIG. 4, when the detected object material and auxiliary information are different from all object materials and auxiliary information that are stored in the terminal, perform step 40: Store, in the terminal, the detected object material and auxiliary information and an application mode input by the user. It should be noted that, when the detected object material and auxiliary information are different from all object materials and auxiliary information that are stored in the terminal, a reminder may be displayed to the user, asking the user whether to add the object material and auxiliary information. If the user selects not to add the object material and auxiliary information, the terminal discards the detected object material and auxiliary information; if the user selects to add the object material and auxiliary information, an application mode setting interface is displayed, and the user may set the application mode of the terminal according to the application mode that is to be used for the object material and the auxiliary information. Finally, the terminal stores, in a storage medium of the terminal, the detected object material and auxiliary information and the application mode input by the user. Because manually adding, to the storage medium of the terminal by the user, a detected object material and auxiliary information and an application mode input by the user is supported, an increasing number of object materials and auxiliary information and application modes corresponding to the object materials and the auxiliary information will be stored in the terminal, so that a possibility for the terminal to select an object material and auxiliary information that are the same as the detected object material and auxiliary information greatly increases.

Still further, when the detected object material is a case material of a notebook computer and the auxiliary information meets a preset condition, a wireless connection function is enabled, so that the terminal and the notebook computer perform data synchronization, where enabling the wireless connection function may be enabling a Bluetooth connection, and may also be enabling an infrared connection. For example, assuming that the object material of the case material of the notebook computer is metal and the geographical position is Longhua in Shenzhen, the wireless connection function is enabled when the detected object material is metal and the geographical position is Longhua in Shenzhen.

It should be noted that, to implement the function of synchronization between the terminal and the notebook computer, support of synchronization software is required. The synchronization software may be installed in the notebook computer, and in this case, the synchronization software in the notebook computer needs to be always on and keep monitoring a wireless connection, the wireless connection function of the notebook computer is always enabled, and the terminal and the notebook computer may automatically perform data synchronization after a wireless connection is established between the terminal and the notebook computer. Alternatively, the synchronization software may also be installed in the terminal, the synchronization software installed in the terminal needs to be started after the wireless connection function of the terminal is enabled, and the terminal and the notebook computer may automatically perform data synchronization after a wireless connection is established between the terminal and the notebook computer.

In addition, common case materials of notebook computers include an alloy case and a plastic case, where the alloy case includes an aluminum-magnesium alloy and a titanium alloy, and the plastic case includes carbon fiber, polycarbonate PC, and ABS engineering plastic. It should be noted that, object materials of the common case materials of notebook computers may be stored before the terminal is delivered from the factory, and object materials of notebook computers that have been in contact with the cell phone may also be stored by the user during use of the terminal.

Because the data synchronization between the terminal and the notebook computer can be enabled as long as the terminal contacts the notebook computer and the auxiliary information meets a preset condition, relevant settings for the user to manually perform data synchronization are omitted, thereby effectively simplifying an operation of configuring the application mode.

Optionally, in consideration of security, before the terminal and the notebook computer perform data synchronization, a prompt may be displayed, so that the user decides whether to perform data synchronization between the terminal and the notebook computer. Because whether to perform data synchronization is completely controlled by the user, security of the terminal is greatly improved, thereby providing good privacy protection for the user.

In the method provided by the embodiment of the present invention, a mobile terminal first detects an object material currently in contact with the terminal and auxiliary information; compares the detected object material and auxiliary information with an object material and auxiliary information that are stored in the terminal; and when the detected object material and auxiliary information are the same as the object material and the auxiliary information that are stored in the terminal, configures an application mode of the terminal as an application mode corresponding to the object material and the auxiliary information that are stored in the terminal. In this way, manual configuration of the application mode for the terminal by a user is omitted, thereby solving a problem that the operation of configuring the application mode is complex. Therefore, with the method provided by the embodiment of the present invention, the application mode of the terminal may be automatically configured according to the detected object material currently in contact with the terminal and auxiliary information, thereby simplifying the operation of configuring the application mode.

### Embodiment 3

As shown in FIG. 5, an embodiment of the present invention provides a mobile terminal, including:

a first detecting module 50, configured to detect an object material currently in contact with the terminal; a first storing module 52, configured to store the detected object material and an application mode input by a user; a first comparing module 54, configured to compare the object material detected by the first detecting module 50 with an object material stored in the first storing module 52; and a first configuring module 56, configured to: when a comparison result of the first comparing module 54 is that the object material detected by the first detecting module 50 is the same as the object material stored in the first storing module 52, configure an application mode of the terminal as an application mode corresponding to the object material stored in the terminal.

Further, as shown in FIG. 6, when the comparison result of the first comparing module is that the object material detected by the first detecting module is different from all object materials stored in the first storing module, the mobile terminal further includes: a first adding module 58, configured to send, to the first storing module 52, the object material detected by the first detecting module 50 and the application mode input by the user.

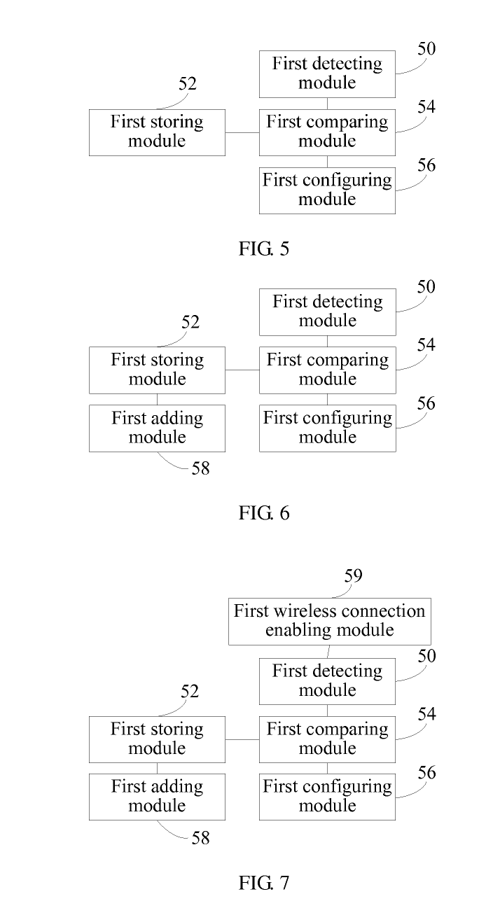

Still further, as shown in FIG. 7, when the detected object material is a case material of a notebook computer, the mobile terminal further includes: a first wireless connection enabling module 59, configured to enable a wireless connection function, so that the terminal and the notebook computer perform data synchronization.

For operation steps of the modules in this device embodiment, reference may be made to corresponding content in Embodiment 1, for effects that can be brought about by the operation steps, reference may also be made to corresponding content in Embodiment 1, and details are not repeatedly described herein.

In the device provided by the embodiment of the present invention, the first detecting module 50 of the mobile terminal first detects an object material currently in contact with the terminal; the first comparing module 54 compares the object material detected by the first detecting module 50 with an object material stored in the first storing module 52; and when a comparison result of the first comparing module 54 is that the object material detected by the first detecting module 50 is the same as the object material stored in the first storing module 52, an application mode of the terminal is configured to an application mode corresponding to the object material stored in the terminal. In this way, manual configuration of the application mode for the terminal by a user is omitted, thereby solving a problem that the operation of configuring the application mode is complex. Therefore, with the device provided by the embodiment of the present invention, the application mode of the terminal may be automatically configured according to the detected object material currently in contact with the terminal and auxiliary information, thereby simplifying the operation of configuring the application mode.

In Embodiment 1 and Embodiment 3 of the present invention, the mobile terminal may be a device such as a mobile phone, a navigator, a man-machine interaction terminal, an e-book, an audio and video player or a personal digital assistant PDA, or another terminal device with a display function, but is not limited to the foregoing devices. For example, when the mobile terminal is a mobile phone, that is, a cell phone, the cell phone may include the following parts: a case, a circuit board, a processor, a touchscreen, a radio frequency circuit, a microphone, a speaker, a power supply, and so on. The touchscreen is disposed on the case, the circuit board is disposed inside a space enclosed by the case, and the processor and the radio frequency circuit are disposed on the circuit board. Furthermore, the processor includes the first detecting module 50, the first storing module 52, the first comparing module 54, and the first configuring module 56 in Embodiment 3 of the present invention. In addition, when the comparison result of the first comparing module is that the object material detected by the first detecting module 50 is different from all object materials stored in the first storing module 52, the processor further includes the first adding module 58; and when the detected object material is a case material of a notebook computer, the processor further includes the first wireless connection enabling module 59. Specifically, the processor is configured to process data, which is input through the touchscreen, and/or output a processed data result through the touchscreen. The radio frequency circuit is configured to establish communication between the cell phone and a wireless network, and implement data receiving and sending between the cell phone and the wireless network. The microphone is configured to collect a sound and convert the collected sound to sound data, so that the cell phone sends the sound data to the wireless network through the radio frequency circuit. The speaker is configured to restore the sound data to a sound and play the sound for the user, where the sound data is received by the cell phone from the wireless network through the radio frequency circuit. The power supply is configured to supply power to all circuits or components of the cell phone.

### Embodiment 4

As shown in FIG. 8, an embodiment of the present invention provides another mobile terminal, including: a second detecting module 80, configured to detect an object material currently in contact with the terminal and auxiliary information; a second storing module 82, configured to store the detected object material and auxiliary information and an application mode input by a user; a second comparing module 84, configured to compare the object material and the auxiliary information that are detected by the second detecting module 80 with the object material and the auxiliary information that are stored in the second storing module 82; and a second configuring module 86, configured to: when a comparison result of the second comparing module 84 is that the object material and the auxiliary information that are detected by the second detecting module are the same as the object material and the auxiliary information that are stored in the second storing module 82, configure an application mode of the terminal as an application mode corresponding to the object material and the auxiliary information that are stored in the second storing module 82.

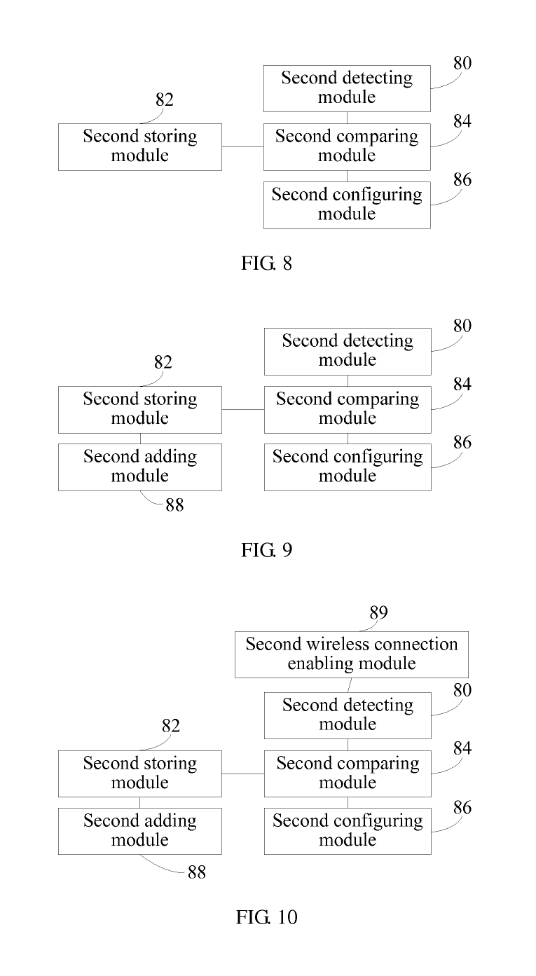

Further, as shown in FIG. 9, when the comparison result of the second comparing module 84 is that the object material and the auxiliary information that are detected by the second detecting module 80 are different from all object materials and auxiliary information that are stored in the second storing module 82, the mobile terminal further includes a second adding module 88, configured to send, to the second storing module 82, the application mode input by the user and the detected object material and auxiliary information.

Still further, as shown in FIG. 10, when the detected object material is a case material of a notebook computer and the auxiliary information meets a preset condition, the mobile terminal further includes a second wireless connection enabling module 89, configured to enable a wireless connection function, so that the terminal and the notebook computer perform data synchronization.

In this device embodiment, for operation steps of the modules, reference may be made to corresponding content in Embodiment 2, for effects that can be brought about by the operation steps, reference may also be made to corresponding content in Embodiment 2, and details are not repeatedly described herein.

In the device provided by the embodiment of the present invention, the first detecting module 80 of the mobile terminal first detects an object material currently in contact with the terminal and auxiliary information; the first comparing module 84 compares the object material and the auxiliary information that are detected by the first detecting module 80 with an object material and auxiliary information that are stored in the first storing module 82; and when a comparison result of the first comparing module 84 is that the object material and the auxiliary information that are detected by the first detecting module 80 are the same as the object material and the auxiliary information that are stored in the first storing module 82, an application mode of the terminal is configured to an application mode corresponding to the object material and the auxiliary information that are stored in the terminal. In this way, manual configuration of the application mode for the terminal by a user is omitted, thereby solving a problem that the operation of configuring the application mode is complex. Therefore, with the device provided by the embodiment of the present invention, the application mode of the terminal may be automatically configured according to the detected object material currently in contact with the terminal and auxiliary information, thereby simplifying the operation of configuring the application mode.

In Embodiment 2 and Embodiment 4 of the present invention, the mobile terminal may be a device such as a mobile phone, a navigator, a man-machine interaction terminal, an e-book, an audio and video player or a personal digital assistant PDA, or another terminal device with a display function, but is not limited to the foregoing devices. For example, when the mobile terminal is a mobile phone, that is, a cell phone, the cell phone may include the following parts: a case, a circuit board, a processor, a touchscreen, a radio frequency circuit, a microphone, a speaker, a power supply, and so on. The touchscreen is disposed on the case, the circuit board is disposed inside a space enclosed by the case, and the processor and the radio frequency circuit are disposed on the circuit board. Furthermore, the processor includes the second detecting module 80, the second storing module 82, the second comparing module 84, and the second configuring module 86 in Embodiment 3 of the present invention. In addition, when the comparison result of the second comparing module is that the object material detected by the second detecting module 80 is different from all object materials stored in the second storing module 82, the processor further includes the second adding module 88; and when the detected object material is a case material of a notebook computer, the processor further includes the second wireless connection enabling module 89. Specifically, the processor is configured to process data, which is input through the touchscreen, and/or output a processed data result through the touchscreen. The radio frequency circuit is configured to establish communication between the cell phone and a wireless network, and implement data receiving and sending between the cell phone and the wireless network. The microphone is configured to collect a sound and convert the collected sound to sound data, so that the cell phone sends the sound data to the wireless network through the radio frequency circuit. The speaker is configured to restore the sound data to a sound and play the sound for the user, where the sound data is received by the cell phone from the wireless network through the radio frequency circuit. The power supply is configured to supply power to all circuits or components of the cell phone.

The foregoing descriptions are merely specific implementation manners of the present invention, but are not intended to limit the protection scope of the present invention. Any variation or replacement readily figured out by a person skilled in the art within the technical scope disclosed in the present invention shall fall within the protection scope of the present invention. Therefore, the protection scope of the present invention shall be subject to the protection scope of the claims.

It should be noted that in the foregoing method and device, the units included are divided only by functional logic, but is not limited to the preceding dividing, as long as the corresponding functions can be implemented; in addition, specific names of various functional units are intended to distinguish between the functional units, but not to limit the protection scope of the present invention.

It should also be understood that, although terms such as first and second may be used herein to describe various elements or data, these elements or data should not be limited to these terms. These terms are only used to distinguish the components or data from each other. For example, without departing from the scope of the present invention, a first module may also be called a second module, and similarly, a second module may be called a first module.

A person of ordinary skill in the art may understand that all or a part of the processes of the methods in the embodiments may be implemented by a computer program instructing relevant hardware. The program may be stored in a computer readable storage medium. When the program runs, the procedures of the foregoing method embodiments are performed. The foregoing storage medium may include: a magnetic disk, an optical disc, a read-only memory (ROM) or a random access memory (RAM), and the like.

To sum up, the foregoing descriptions are merely exemplary embodiments of the present invention, but are not intended to limit the protection scope of the present invention. Any modification, equivalent replacement, or improvement made within the spirit and principle of the present invention shall fall within the protection scope of the present invention.

What is claimed is:

1. A method for configuring an application mode of a terminal, the method comprising:
detecting an object material currently in contact with the terminal;
comparing the detected object material with an object material stored in the terminal;
determining whether the detected object material is the same as or different from the object material stored in the terminal; and
when the detected object material is the same as the object material stored in the terminal, configuring the application mode of the terminal to be an application mode corresponding to the object material stored in the terminal.

2. The method according to claim 1, further comprising:
determining that the detected object material is different from all object materials stored in the terminal;
receiving an application mode input corresponding to the detected object material; and
saving, to the terminal, the detected object material and the received application mode input.

3. The method according to claim 1, further comprising:
determining that the detected object material is a case material of a notebook computer; and
enabling a wireless connection function, so that the terminal and the notebook computer perform data synchronization.

4. A method for configuring an application mode of a terminal, the method comprising:
detecting an object material currently in contact with the terminal and auxiliary information;
comparing the detected object material and auxiliary information with an object material and auxiliary information that are stored in the terminal;
determining whether the detected object material and auxiliary information are the same as or different from the object material and the auxiliary information that are stored in the terminal; and
when the detected object material and auxiliary information are the same as the object material and the auxiliary information that are stored in the terminal, configuring the application mode of the terminal as an application mode corresponding to the object material and the auxiliary information that are stored in the terminal.

5. The method according to claim 4, wherein the auxiliary information comprises a combination of one or more of the following: geographical position, time, date, movement status of the terminal, and brightness status of an environment where the terminal is located.

6. The method according to claim 4, further comprising:
determining that the detected object material and auxiliary information are different from all object materials and auxiliary information that are stored in the terminal;
receiving an application mode input corresponding to the detected object material and auxiliary information; and
saving, to the terminal, the detected object material and auxiliary information and an application mode input.

7. The method according to claim 4, further comprising:
determining that the detected object material is a case material of a notebook computer and the auxiliary information meets a preset condition; and
enabling a wireless connection function, so that the terminal and the notebook computer perform data synchronization.

8. A mobile terminal comprising:
a detecting module configured to detect an object material currently in contact with the terminal;
a storing module configured to store the detected object material and an application mode input received at an input node;
a comparing module configured to compare the object material detected by the detecting module with an object material stored in the storing module and determine whether the detected object material is the same as or different from the object material stored in the terminal; and
a configuring module configured to configure an application mode of the terminal as an application mode corresponding to the object material stored in the terminal when a comparison result of the comparing module is that the object material detected by the detecting module is the same as the object material stored in the storing module.

9. The mobile terminal corresponding to claim 8, wherein when the comparison result of the comparing module is that the object material detected by the detecting module is different from all object materials stored in the storing module, the mobile terminal further comprises:
an adding module configured to send, to the storing module, the object material detected by the detecting module and an application mode input received from an input device.

10. The mobile terminal according to claim 9, wherein the input device comprises a touchscreen configured to obtain the application mode input.

11. The mobile terminal according to claim 8, wherein when the detected object material is a case material of a notebook computer, the mobile terminal further comprises:
a wireless connection enabling module configured to enable a wireless connection function, so that the terminal and the notebook computer perform data synchronization.

12. The mobile terminal according to claim 8, wherein the mobile terminal is a cell phone, and the cell phone further comprises: a sensor, a case, a circuit board, a processor, a touchscreen, a radio frequency circuit, a microphone, a speaker, and a power supply, wherein
the sensor is configured to detect an object material currently in contact with the terminal, and transmit detected information to the processor;
the touchscreen is disposed on the case, the circuit board is disposed inside a space enclosed by the case, and the processor and the radio frequency circuit are disposed on the circuit board;
the processor comprises all or a part of the modules; the processor is configured to process data, which is input through the touchscreen, and/or output a processed data result through the touchscreen;
the radio frequency circuit is configured to establish communication between the cell phone and a wireless network, and implement data receiving and sending between the cell phone and the wireless network;
the microphone is configured to collect a sound and convert the collected sound to sound data, so that the cell phone sends the sound data to the wireless network through the radio frequency circuit;
the speaker is configured to restore the sound data to a sound and play the sound, where the sound data is received by the cell phone from the wireless network through the radio frequency circuit; and
the power supply is configured to supply power to all circuits or components of the cell phone.

13. A mobile terminal comprising:
a detecting module configured to detect an object material currently in contact with the terminal and auxiliary information;
a storing module configured to store the detected object material and auxiliary information and an application mode input;
a comparing module configured to compare the object material and the auxiliary information that are detected by the detecting module with an object material and auxiliary information that are stored in the storing module; and
a configuring module configured to configure an application mode of the terminal as an application mode corresponding to the object material and the auxiliary information that are stored in the storing module when a comparison result of the comparing module is that the object material and the auxiliary information that are detected by the detecting module are the same as the object material and the auxiliary information that are stored in the storing module.

14. The mobile terminal corresponding to claim 13, wherein when the comparison result of the comparing module is that the object material and the auxiliary information that are detected by the detecting module are different from all object materials and auxiliary information that are stored in the storing module, the mobile terminal further comprises:
a adding module, configured to send, to the storing module, an application mode input from an input device and the detected object material and auxiliary information.

15. The mobile terminal according to claim 14, wherein the input device comprises a touchscreen configured to obtain the application mode input.

16. The mobile terminal according to claim 13, wherein when the detected object material is a case material of a notebook computer and the auxiliary information meets a preset condition, mobile terminal further comprises:
a wireless connection enabling module, so that the terminal and the notebook computer perform data synchronization.

17. The mobile terminal according to claim 8, wherein the mobile terminal is a cell phone, and the cell phone further comprises: a sensor, a case, a circuit board, a processor, a touchscreen, a radio frequency circuit, a microphone, a speaker, and a power supply, wherein
the sensor is configured to detect an object material currently in contact with the terminal, and transmit detected information to the processor;
the touchscreen is disposed on the case, the circuit board is disposed inside a space enclosed by the case, and the processor and the radio frequency circuit are disposed on the circuit board;
the processor comprises all or a part of the modules; the processor is configured to process data, which is input through the touchscreen, and/or output a processed data result through the touchscreen;
the radio frequency circuit is configured to establish communication between the cell phone and a wireless network, and implement data receiving and sending between the cell phone and the wireless network;
the microphone is configured to collect a sound and convert the collected sound to sound data, so that the cell phone sends the sound data to the wireless network through the radio frequency circuit;
the speaker is configured to restore the sound data to a sound and play the sound, where the sound data is received by the cell phone from the wireless network through the radio frequency circuit; and
the power supply is configured to supply power to all circuits or components of the cell phone.
